(19) United States
(12) Patent Application Publication
(10) Pub. No.: US 2026/0165531 A1
(43) Pub. Date: Jun. 18, 2026

(54) OUTDOOR COOKING APPARATUS AND METHOD OF USING SAME

(71) Applicant: John Hickman, Prosper, TX (US)

(72) Inventor: John Hickman, Prosper, TX (US)

(21) Appl. No.: 19/420,545

(22) Filed: Dec. 15, 2025

Related U.S. Application Data
(60) Provisional application No. 63/734,605, filed on Dec. 16, 2024.

(51) Int. Cl. A47J 37/12; A23L 5/10; A47J 27/10; A47J 36/02; A47J 36/04

(52) U.S. Cl. CPC A47J 37/1219; A23L 5/11; A23L 5/13; A47J 27/10; A47J 36/02; A47J 36/04; A47J 37/1204; A47J 37/1285; A47J 37/129; A47J 37/1295

(57) ABSTRACT

An outdoor cooking apparatus is disclosed. The apparatus includes a cooking vessel with a cooking platform located within the cooking vessel, wherein movement of the cooking platform is controlled through a hinge mechanism connected to a handle. Food pieces are placed on the cooking platform and then the handle positions the cooking platform into a heated cooking medium within the cooking vessel, like oil or water, to immerse and cook the food pieces. The handle then is used to position the cooking platform and food out of the cooking medium. The handle is placed in a locking mechanism to secure the cooking platform out of the cooking medium and to drain any excess cooking medium back into the cooking vessel for future use. The cooking vessel can be placed on a supporting base configured with shelving, wheels, a control panel, and heat source with fuel for the cooking medium.

### CROSS-REFERENCE TO RELATED APPLICATION(S)

This application claims priority to U.S. Provisional Application No. 63/734,605, filed Dec. 16, 2024. This patent application is incorporated by reference herein in its entirety to provide continuity of disclosure.

### FIELD OF THE INVENTION

This disclosure relates to an outdoor cooking apparatus and method of using the same for preparing food, such as through boiling or frying. In particular, the present invention relates to a cooking vessel with a cooking platform that is located within the cooking vessel that can move into and out of a cooking medium used to cook food within the cooking vessel. The cooking platform's movement is accomplished by a mechanism that moves the cooking platform into the cooking medium to immerse uncooked food, and then subsequently moves the cooking platform out of the cooking medium to remove the cooked food.

### BACKGROUND OF THE INVENTION

Several cooking apparatuses exist that cook food by boiling or frying. Such apparatuses have a vessel that holds a volume of cooking medium, such as water, oil, or melted shortening. The cooking medium is heated to a desired cooking temperature by an external heat source, such as an electrical heating element or a flame generated by a gaseous or organic fuel. When the cooking medium reaches the desired temperature, food pieces are placed into the cooking medium and allowed to boil or fry, after which the food is retrieved from the hot cooking medium for consumption.

Foods typically cooked in these types of apparatuses include snacks or foods such as battered and coated chicken, vegetables, fish, or non-battered items like French fries or donuts that are fried in heated oil. If water is used as the cooking medium, foods like seafood or vegetables can be boiled or steamed using the cooking apparatus.

To cook these types of foods, traditional cooking apparatus designs utilize baskets or similar types of containment vessels to the limit movement of them food items while being immersed and cooked by the heated cooking medium. To accommodate these baskets, the vessel holding the cooking medium must be sufficiently deep to enable the basket and food to be sufficiently immersed in the cooking medium. Certain designs may require deep containment vessels where the user must carefully reach into and retrieve food items out of a large volume of heated cooking medium, thereby increasing the user's risk for injury.

Alternatively, if no basket is used, the user must individually place each individual food item into the heated cooking medium and then later retrieve each cooked food piece one at a time. This repetitive and labor intensive process not only increases cooking times but can lead to uneven cooking times if individual food pieces are placed in the cooking medium at different times. Uneven cooking times present health concerns if the food is undercooked, while overcooked food may be unsatisfactory for consumption. Increased interaction with the heated cooking medium while individually placing food into or retrieving food out of the hot cooking medium also increases the risk of injury.

After the food is cooked, it is desirable to drain the excess cooking medium from the food. Removing the excess cooking medium helps prevent the cooked food from becoming soggy or may be preferred for health considerations by reducing retained fats or oils. Some cooking apparatus designs require the user to lift a basket or vessel with the cooked food out of the heated liquid and turn the basket over around a pivot to dump the food out onto a tray or another storage vessel. Depending on the amount of food being cooked and the volume of heated oil or water involved, the basket may have considerable weight making the operation dangerous for the user. Additionally, these designs may necessitate that the user place their hands in close proximity to the heated cooking medium, thereby increasing the risk of injury. Movement of the food during removal can also generate a large amount of steam, which may further pose a burn hazard to the user's hands. These designs may also cause a portion of the cooking medium be removed with the food, reducing the amount of cooking medium available for subsequent cooking operations. If the food items are delicate, dumping them from the cooking vessel or basket may be undesirable, as doing so can cause the food items to be jostled, deform, or otherwise lose their structural integrity and visual appeal.

An outdoor cooking device may also have space constraints and should be easily transportable, if desired. Certain design features may be helpful for the outdoor cooking apparatus user that may not be important considerations in a similar cooking apparatus found in an indoor consumer or commercial kitchen. For instance, an indoor cooking apparatus may have sufficient height and structural components to suspend baskets of cooked food, allowing excess cooking medium to drain from the cooked food back into the vessel with the cooking medium. An indoor cooking apparatus may also have greater storage capacity or may not need to be portable. Some outdoor cooking apparatuses are designed exclusively to fry food while others are designed to only boil food. The different characteristics of the cooking mediums, such as hot oil or boiling water, may require different design considerations to ensure safe handling across multiple cooking techniques. While the preferred use of this cooking apparatus is outdoors, those skilled in the art may recognize that this outdoor cooking apparatus may be used indoors after following proper safety precautions or adherence to local safety regulations.

Therefore, it is desirable to have an outdoor cooking apparatus that can cook foods efficiently, evenly, and safely while minimizing the user's interaction with the heated cooking medium across multiple cooking techniques. It is also desirable for the apparatus to be compact and transportable for use in an outdoor environment. There is a need for a cooking apparatus that includes a cooking platform positioned within the cooking vessel and configured to move in response to a user's input. The platform should be capable of immersing food into the cooking medium, subsequently raising the cooked food out of the medium for draining, and improving overall cooking efficiency and food quality while reducing the user's risk of injury.

### SUMMARY

The disclosed embodiments disclose an outdoor cooking apparatus including a cooking vessel with a cooking platform located within the cooking vessel that moves the position of the cooking platform based on the user's manual input. A preferred embodiment utilizes a hinged mechanism with a handle to move the cooking platform during use from a first position to a second position within a cooking medium, like heated oil or water, and then subsequently moving the cooking platform back to a first position outside of the cooking medium. In a preferred embodiment, the handle can be locked in place thereby locking the cooking platform in a first position within the cooking vessel. This allows the user to easily position food pieces onto the cooking platform before unlocking the handle and moving the cooking platform to a second position in the heated cooking medium. The locking mechanism also allows the user to suspend the cooked food in the first position above the surface of the cooking medium, allowing excess cooking medium to drain away from the cooked food back into the cooking vessel. This invention offers improved cooking efficiency, quality, and safety while frying or boiling food in an outdoor environment across multiple cooking techniques.

The ability to position the cooking platform into the cooking medium and immerse all of the food pieces at the same time within cooking medium ensures that the food is consistently cooked for higher quality, thereby reducing the risk of individual food pieces being undercooked or overcooked. The cooking platform's lower cooking surface is constructed from a material with a set of openings allows the excess cooking medium to drain from the food back into the cooking vessel after the cooked food pieces are simultaneously moved to the first position out of the cooking medium. This helps minimize wastage or loss of the cooking medium following removal of the food and lowers the amount of cooking medium retained on the food.

The handle operated mechanism reduces the user's proximity to and direct interaction with the heated cooking medium, which significantly improves user safety in the outdoor environment where ready access to medical treatment to treat burns may be limited. Furthermore, by allowing controlled and stable movement of the food relative to the cooking medium, the mechanism decreases the risk of sudden tipping or unsteady handling that might otherwise occur if the user were required to manually lift, pivot, or maneuver baskets around the heated cooking medium. The gentle controlled movement between the first and second positions also helps maintain the structural integrity and visual appeal of delicate food items.

Positioning the cooking platform within the cooking vessel enables a compact design that eliminates the need to have separate frying or boiling baskets, or the need to have additional cabinets, racks, or shelving to store such components above or besides the cooking apparatus. When cooking outdoors, consolidation of the functional elements of the equipment is preferred to reduce the number of loose pieces of equipment and supplies that need to be transported to the cooking location and stored.

In a preferred embodiment, the outdoor cooking apparatus is located on a supportive frame structure with shelving and storage for cooking materials, cooking equipment, and a fuel source to generate heat. A control panel is situated on the frame to regulate the flow of gaseous fuel or electrical current used to heat the cooking medium by flame or heating element. An igniter to light gaseous fuel and a temperature gauge to monitor the cooking medium is also present in a preferred embodiment. In some embodiments, the cooking vessel and medium are heated by burning wood, charcoal, or other organic matter known in the art underneath the cooking vessel. Also present in a preferred embodiment are wheels that are attached to the bottom of the frame for ease of transportation and relocation of the cooking apparatus.

### BRIEF DESCRIPTION OF THE DRAWINGS

In the detailed description presented below, reference will be made to the following drawings.

FIG. 1 is a perspective view of the outdoor cooking apparatus of a preferred embodiment.

FIG. 2 is a front view of the outdoor cooking apparatus of a preferred embodiment.

FIG. 3 is a close-up perspective view of the cooking vessel of a preferred embodiment with the cooking platform in a first position.

FIG. 4 is a close-up perspective view of the cooking vessel of a preferred embodiment with the cooking platform in a second position.

FIG. 5 is a close-up cross-sectional side view of the cooking vessel of a preferred embodiment with the cooking platform in a first position.

FIG. 6 is a close-up cross-sectional side view of the cooking vessel of a preferred embodiment with the cooking platform in a second position.

### DETAILED DESCRIPTION

The embodiments disclosed herein enable the cooking of food using a cooking apparatus with a handle operated cooking platform located within a cooking vessel to move the cooking platform from a first position to a second position into a cooking medium, such as water or oil, and then subsequently moving back to the first position out of the cooking medium. The platform allows food to be cooked with greater efficiency by simultaneously immersing all food pieces into the cooking medium in a stable controlled manner, and then simultaneously raising all food pieces out of the cooking medium. This ensures consistent cooking durations for all individual food pieces; reduces wastage of the cooking medium; and improves user safety across multiple cooking techniques compared to alternative apparatuses that boil or fry food in an outdoor environment.

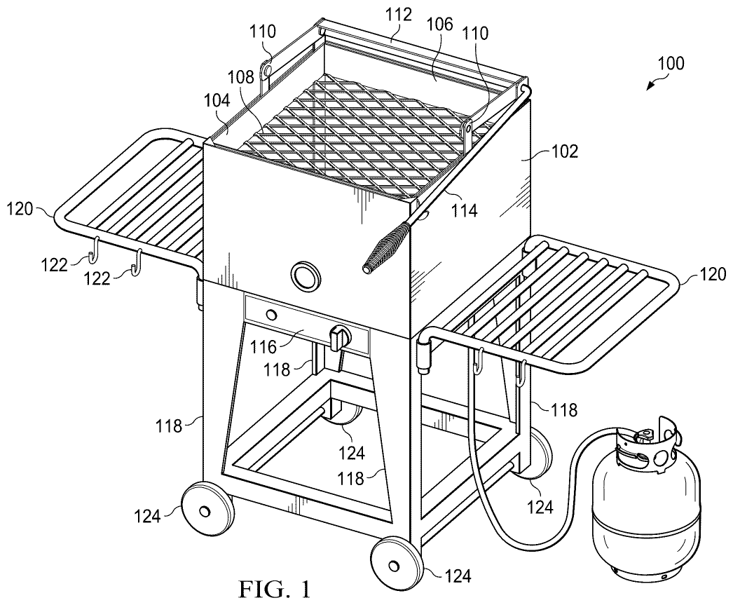

Referring to FIG. 1, the outdoor cooking apparatus 100 includes a main cooking vessel 102. Cooking vessel 102 includes at least one exterior side surface. In some embodiments, the cooking vessel includes only one exterior side surface and a bottom surface forming a circular vessel. In a preferred embodiment as shown, the cooking vessel includes four exterior sides and a bottom side forming a square vessel. In a preferred embodiment, the cooking vessel 102 is constructed of welded or formed durable material, such as a metal alloy. Other suitable durable materials known in the art may be employed to construct cooking vessel 102. In some embodiments, cooking vessel 102 includes a protective cover that encloses over the top opening of cooking vessel 102.

In some embodiments, the metal of cooking vessel 102 is coated with a heat resistant non-porous wipeable material, like porcelain or enamel. Other suitable non-porous wipeable materials known in the art may be employed.

In some embodiments, the components of outdoor cooking apparatus 100 are constructed of a durable material such as a metal alloy. Other suitable durable materials known in the art may be employed.

Located within cooking vessel 102 is cooking platform 104. In a preferred embodiment, cooking platform 104 is shaped closely to the interior top-down shape of cooking vessel 102. In a preferred embodiment as shown, cooking platform 104 includes four vertical walls 106 and a platform cooking surface 108 with openings. In a preferred embodiment, the vertical walls 106 have a height of approximately 3 inches. Other suitable heights known in the art may be employed for vertical walls 106. In a preferred embodiment as shown, the gap between cooking vessel 102's interior vertical wall surface and cooking platform 104's vertical wall 106 exterior surface are sufficient to allow movement between the two.

The platform cooking surface 108 of cooking platform 104 includes a set of openings that allow cooking medium to pass through the platform cooking surface 108 to immerse the food pieces to be cooked when the cooking platform 104 is in a second position, or suspending the food pieces out of the cooking medium when the cooking platform 104 is in a first position. In a preferred embodiment as shown, platform cooking surface 108 includes a diamond lattice pattern. In other embodiments, platform cooking surface 108 is formed from a material with other patterns, such as a linear slotted bar pattern in horizontal or vertical orientation, a square grid forming a mesh, perforations, or other suitable materials known in the art. The platform cooking surface 108 openings also allow excess cooking medium to drain from the food back into cooking vessel 102 when cooking platform 104 is in a first position within cooking vessel 102. In a preferred embodiment, the cooking platform 104 and platform cooking surface 108 are constructed of welded or formed durable material, such as a metal alloy. Other suitable materials known in the art may be employed.

The cooking platform 104 is connected to cooking vessel 102 with at least one method of connection. In a preferred embodiment as shown, a set of hinges 110 are attached to the sides of two opposing vertical walls 106. In a preferred embodiment as shown, the hinge ends connected to cooking vessel 102 are linked with a connecting bar 112 enabling the set of hinges to move in unison. A handle 114 is fixed to a pivot point of at least one hinge 110.

Cooking vessel 102 includes a control panel 116 used to regulate the flow of gaseous fuel or electrical current to heat and control the temperature of the cooking medium residing within the cooking vessel 102. In a preferred embodiment as shown, the control panel 116 is located within a base 118. In other embodiments, base 118 holds wood, charcoal, or other organic matter known in the art that can be burned underneath cooking vessel 102 to heat the cooking vessel and cooking medium located within cooking vessel 102. In other embodiments, cooking vessel 102 can hold underneath the bottom surface of cooking vessel 102 wood, charcoal, or other organic matter known in the art that can be burned to heat the cooking vessel and cooking medium.

In some embodiments, base 118 comprises of at least one leg 120. In a preferred embodiment as shown, the base 118 comprises four interconnected legs 120 and shelving 120 affixed to the sides of base 118 for storage of food and cooking supplies. In some embodiments, the shelf 120 includes hooks 122 affixed to it for storage and for hanging cooking utensils or similar equipment. The upper surface of shelving 120 includes a solid piece of material, perforated sheet, grid, openwork, lattice, or slotted material as represented in FIG. 1. Other suitable materials known in the art may be employed.

In a preferred embodiment as shown, a wheel 124 is affixed to the bottom of each leg 120 to enable mobility of the cooking apparatus. In some embodiments, the components of the base 118, shelving 120, hooks 122, and wheels 124 are constructed of a durable material such as a metal alloy, thermoplastic, thermoset material, or a combination thereof.

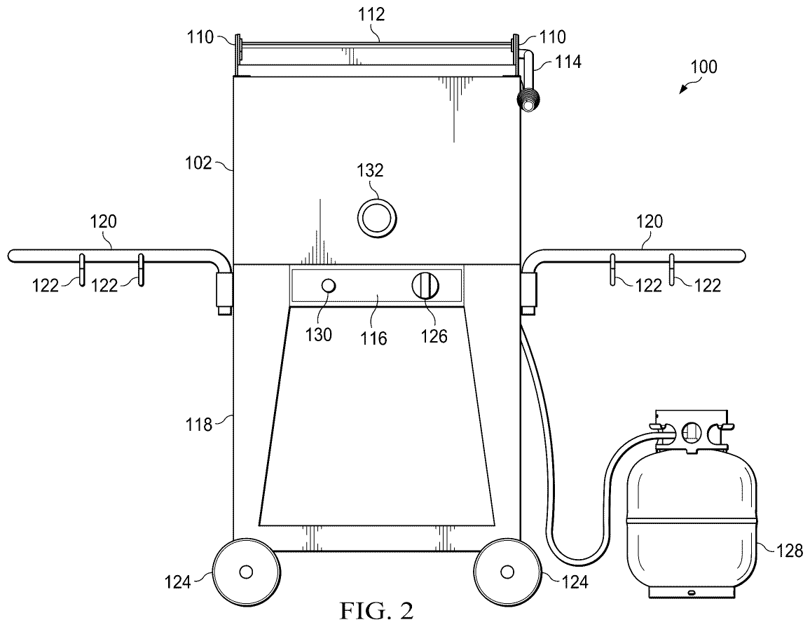

Referring to FIG. 2, in a preferred embodiment as shown, a temperature gauge 132 is connected to cooking vessel 102. The temperature gauge 132 measures the temperature of the cooking medium within cooking vessel 102 to inform the user. In some embodiments, the temperature gauge 132 is located on the control panel 116. In other embodiments, the control panel 116 includes at least one dial 126 that the user rotates to control the flow of gaseous fuel from a fuel supply vessel 128. In other embodiments, the gaseous fuel supply vessel 128 is stored within base 118, off the exterior surface of base 118, or resides on the ground besides the cooking apparatus. In some embodiments, the fuel supply vessel 128 is hung off the ground from a hook or a weight-based fuel supply meter (not shown) attached to the exterior surface of base 118. In a preferred embodiment as shown, the control panel 116 also houses an igniter 130 to ignite the gaseous fuel to allow heating of the cooking medium located within the cooking vessel. In some embodiments using electrical heating, the base 118 houses a power supply with an electrical heat source and an electrical cord. In some embodiments, control panel 116 is analog comprising dials or mechanical switches, or a combination thereof. In other embodiments, control panel 116 is digital comprising a digital screen to display information and control the operation of the cooking apparatus.

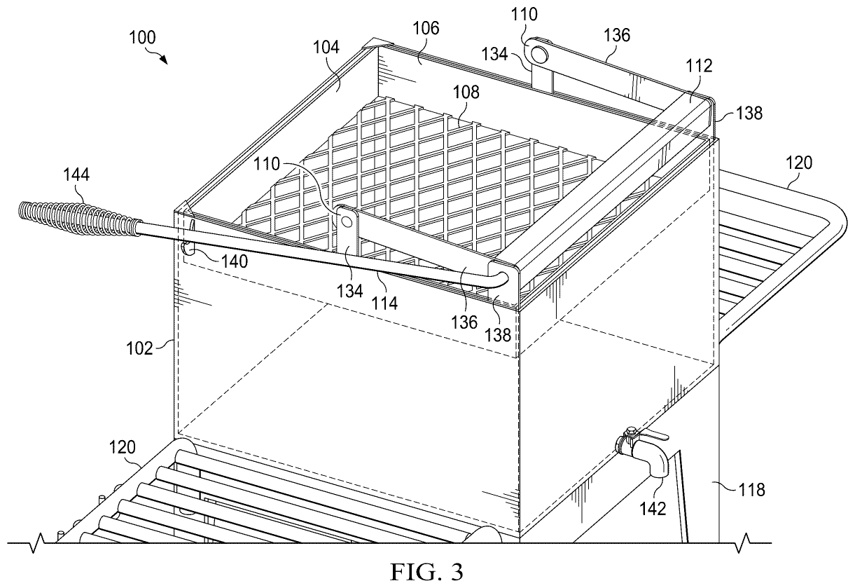

FIG. 3 illustrates a close-up cross-sectional view of cooking vessel 102 with the cooking platform 104 in a first position within cooking vessel 102. The cooking platform 104 is physically linked to cooking vessel 102 with at least one method of connection. In a preferred embodiment as shown, a first end 134 of the set of hinges 110 are attached to the sides of two opposing vertical walls 106 forming two attachment points, which increases stability of cooking platform 104 during its movement and use. The second end 136 of the set of hinges 110 are attached to tabs 138 extending from two opposite corners of the walls of cooking vessel 102. The hinge 110 second ends are mechanically fixed to tabs 138 by screw, rivet, bolt, or another similar type of fastener allowing for rotational movement of the second ends 136 of the set of hinges 110. The second ends 136 are linked with a connecting bar 112 enabling the second ends 136 to rotate in unison.

In a preferred embodiment as shown in FIG. 3, a handle 114 extends from the pivot point where a single hinge 110 second end 136 is secured to tab 138. The handle 114 extends along the length of the side of cooking vessel 102 and terminates at a safe distance beyond the front end of cooking vessel 102. In some embodiments, the handle 114 includes a secondary protective covering 144 to protect the user's hand from excessive heat that transfers to the handle causing discomfort to the user's hand. To secure cooking platform 104 in position, handle 114 rests on a locking hook 140 designed to receive a portion of handle 114 and prevent movement of the handle 114 and the corresponding movement of cooking platform 104 within cooking vessel 102. In other embodiments, hook 140 is replaced with a locking mechanism comprising a catch, latch, detent, or similar locking device that prevents the movement of handle 114 and cooking platform 104 within cooking vessel 102.

In a preferred embodiment as shown in FIG. 3, a drain 142 is connected to cooking vessel 102 to allow the cooking medium to be drained and removed from the cooking vessel 102 after use for cleaning. Drain 142 can also be utilized to flush cleaning solutions out of the cooking vessel. In other embodiments, drain 142 is located on another exterior side, including the bottom surface of cooking vessel 102.

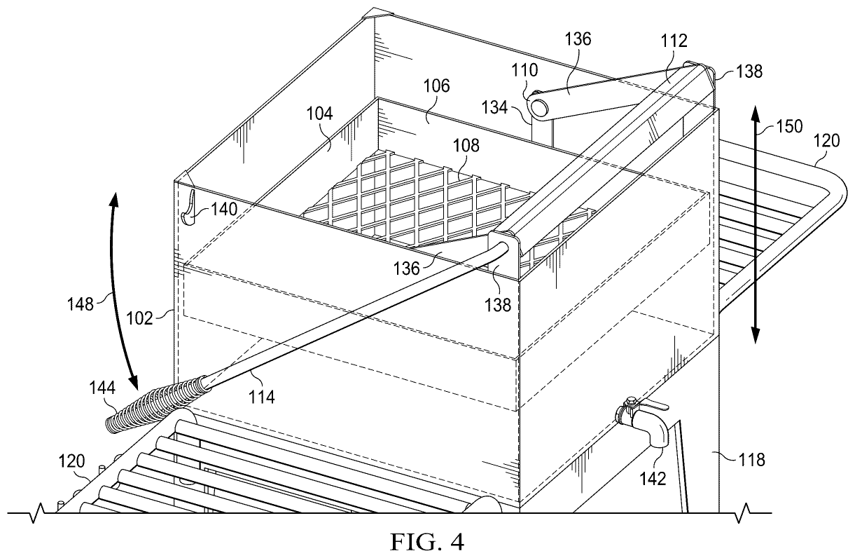

FIG. 4 illustrates a close-up cross-sectional view of cooking vessel 102 with the cooking platform 104 in a second position within cooking vessel 102. During use, the cooking platform 104 is submerged under the surface of the cooking medium thereby allowing the food pieces on platform cooking surface 108 to be immersed and cooked by the cooking medium. To accomplish this, handle 114 is released from locking hook 140 and moved towards a second position. Following the movement of handle 114, the linked second ends 136 of hinges 110 and connecting bar 112 rotationally pivot around the fixture points on tabs 138. In the preferred embodiment, the degree of rotation around the fixture points on tabs 138 and movement of cooking platform 104 across distance 150 is regulated by movement 148 of handle 114. In other embodiments the hinge and handle operated mechanism to control the movement of cooking platform 104 across distance 150 is accomplished with chains, cables, guides, a pulley system, hydraulics, motors, gears, or similar type of mechanical system that is recognized as suitable by an individual skilled in the art to move the cooking platform.

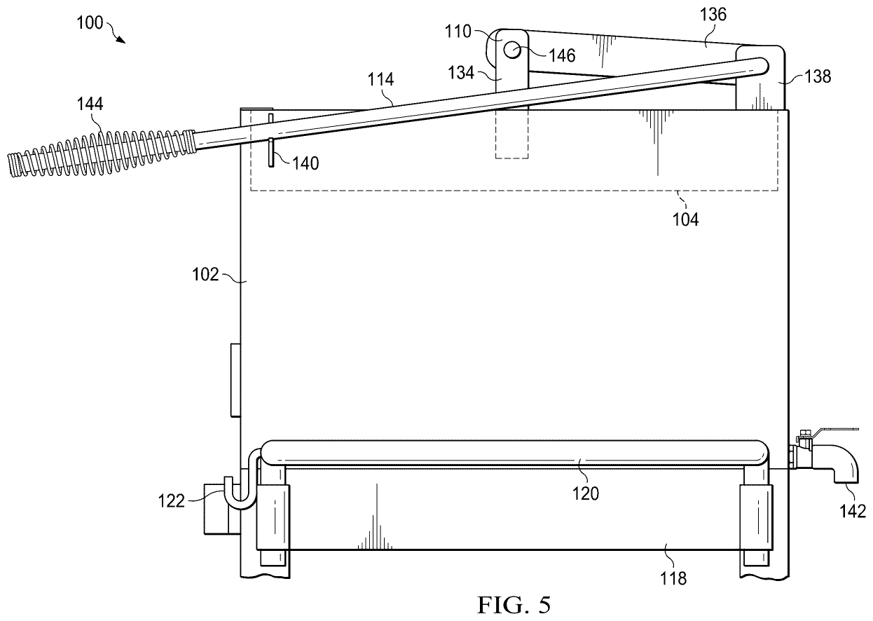

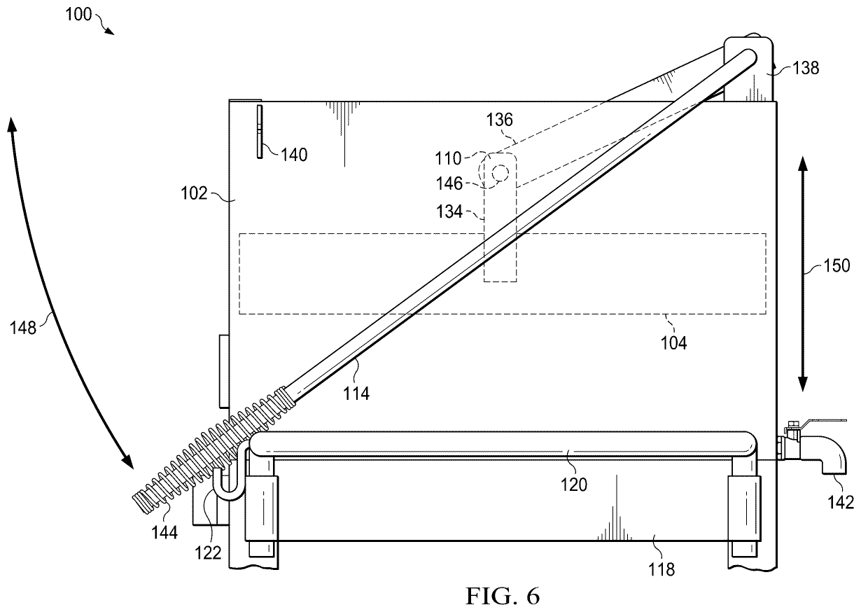

FIGS. 5 and 6 illustrate close-up cross-sectional side views of the cooking vessel 102 showing the cooking platform 104 in the first and second positions, respectively. The set of hinges 110 are each made of a first end 134 that is secured to the cooking platform 104 and a second end 136 that is secured to cooking vessel 102 at tab 138. Both first end 134 and second end 136 are secured together by hinge pin 146. The hinge pins 146 allow the set of hinges 110 to rotationally react to the movement 148 of handle 114 and move cooking platform 104 by distance 150 within cooking vessel 102. The hinges 110 maintain stability of cooking platform 104 during any movements so that the food pieces on platform cooking surface 108 are kept approximately level.

In some embodiments, base 118 is made from a wipeable thermoplastic material such as a (non-limiting examples including polyethylene, polypropylene, acrylonitrile butadiene styrene, polycarbonate, polyvinyl chloride) resin or other suitable thermoplastic material. The thermoplastic material in some embodiments contain reinforcing particulate filler material, including organic material, inorganic material, or both. Alternatively, base 118 is made of a thermoset material (non-limiting examples including polyurethane, epoxy). Other suitable materials known in the art may be employed, including welded or formed durable material, such as a metal alloy.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. A cooking apparatus comprising:
a cooking vessel;
a cooking platform located within the cooking vessel; and
a handle configured to move the cooking platform.

2. The cooking apparatus of claim 1, wherein the cooking platform is connected to the cooking vessel with a hinge mechanism.

3. The cooking apparatus of claim 1, wherein the cooking platform is connected to the cooking vessel with cables.

4. The cooking apparatus of claim 1, wherein the cooking platform further comprises a cooking surface with a set of openings.

5. The cooking apparatus of claim 1, further comprising a drain connected to said cooking vessel.

6. The cooking apparatus of claim 1, wherein the cooking vessel further comprises a locking mechanism to secure the cooking platform in place.

7. The cooking apparatus of claim 1, further comprising a protective cover enclosing the opening of said cooking vessel.

8. The cooking apparatus of claim 1, wherein the apparatus is constructed of a metal alloy, thermoplastic, thermoset material, or a combination thereof.

9. The cooking apparatus of claim 1, further comprising a base connected to said cooking vessel.

10. The cooking apparatus of claim 1, wherein the movement of the cooking platform parallel within the cooking vessel is guided by rails.

11. The cooking apparatus of claim 2, wherein the parallel movement of the cooking platform within the cooking vessel is controlled by said hinge mechanism.

12. The cooking apparatus of claim 2, wherein said hinge mechanism is configured to guide movement of the cooking platform parallel with the cooking vessel.

13. The cooking apparatus of claim 2, wherein the handle is connected to the said hinge mechanism.

14. The cooking apparatus of claim 8, wherein the metal alloy is coated with a non-porous wipeable material.

15. The cooking apparatus of claim 9, wherein the base is constructed of a metal, thermoplastic, thermoset material, or a combination thereof.

16. A method of operating a cooking apparatus, comprising:
Filling the cooking vessel with a cooking medium;
Heating the cooking medium;
Placing food on the cooking platform;
Unlocking the cooking platform by removing the handle from a locking mechanism
Using the handle to move the cooking platform into the cooking medium;
Using the handle to move the cooking platform out of the cooking medium; and
Locking the cooking platform in place by securing the handle.

17. The method of claim 16, further comprising the steps of:
Draining the excess cooking medium back into the cooking vessel; and
Draining the cooking medium out of the cooking vessel when the cooking is complete.

18. The method of claim 16, wherein the step of heating the cooking medium further comprises the step of attaching a heat source to the cooking apparatus and activating said heat source.
